(19) United States
(12) Patent Application Publication
(10) Pub. No.: US 2017/0240785 A1
(43) Pub. Date: Aug. 24, 2017

(54) LOW MONOMER LAMINATING ADHESIVE

(71) Applicant: Dow Global Technologies LLC, Midland, MI (US)

(72) Inventors: Daniele Vinci, Luzern (CH); Thorsten Schmidt, Richterswil (CH)

(73) Assignee: Dow Global Technologies LLC, Midland, MI (US)

(21) Appl. No.: 15/518,904

(22) PCT Filed: Oct. 12, 2015
(86) PCT No.: PCT/US2015/055080

§ 371 Date: Apr. 13, 2017

Related U.S. Application Data
(60) Provisional application No. 62/063,256, filed on Oct. 13, 2014.

(51) Int. Cl. C09J 175/06; C08G 18/76; C08G 18/48; C08G 18/42; C09J 175/08; C08G 18/10

(52) U.S. Cl. CPC C09J 175/06; C09J 175/08; C08G 18/10; C08G 18/48; C08G 18/42; C08G 18/7671; C08G 18/7621

(57) ABSTRACT

The instant invention provides a laminating adhesive composition and laminates for flexible packaging made therefrom. The laminating adhesive composition according to the present invention comprises a) a first prepolymer comprising the reaction product of a methylene diphenyl diisocyanate and a first polyol and b) a second prepolymer comprising the reaction product of an isocyanate and a second polyol, wherein the second prepolymer has less than 0.1 weight percent of free isocyanate monomers.

### REFERENCE TO RELATED APPLICATIONS

The present application claims the benefit of U.S. Provisional Application No. 62/063,256, filed Oct. 13, 2014, which is incorporated herein by reference in its entirety.

### FIELD OF THE INVENTION

The present invention is related to laminating adhesive compositions, and method of making the same.

### BACKGROUND

Materials comprising prepolymers of TDI, MDI, and aliphatic isocyanates are used to achieve fast Primary Aromatic Amine (PAA) decay, which can be as low as three days on critical laminates. However, these compositions have longer curing times due to the lower reactivity of aliphatic isocyanates.

Typical solventless adhesive formulations include one or more polyols reacted with monomeric diisocyanates. An excess of methylene diphenyl diisocyanate (MDI) monomers is used in order to lower the viscosity so these systems can be used on standard solventless laminating machines. An excess of MDI monomers causes slower PAA decays. Therefore, a blend having an increased PAA decay rate while maintaining reasonable curing times would be desirable.

### SUMMARY OF THE INVENTION

The instant invention provides a laminating adhesive composition and laminates for flexible packaging made therefrom.

In one embodiment, the instant invention provides a laminating adhesive composition comprising a) a first prepolymer comprising the reaction product of a methylene diphenyl diisocyanate and a polyol and b) a second prepolymer comprising the reaction product of an isocyanate and a second polyol, wherein the second prepolymer has less than 0.1 weight percent of free isocyanate monomers wherein the laminating adhesive composition is substantially free of solvents.

In another alternative embodiment, the instant invention further provides laminates for flexible packaging comprising the inventive laminating adhesive composition.

### DETAILED DESCRIPTION OF THE INVENTION

The instant invention is a laminating adhesive composition. The instant invention is a laminating adhesive composition substantially free of solvents. The laminating adhesive composition comprises a) a first prepolymer comprising the reaction product of a methylene diphenyl diisocyanate and a polyol and b) a second prepolymer comprising the reaction product of an isocyanate and a second polyol, wherein the second prepolymer has less than 0.1 weight percent of free isocyanate monomers.

The laminating adhesive composition may further include optionally one or more surfactants, optionally one or more dispersants, optionally one or more thickeners, optionally one or more pigments, optionally one or more fillers, optionally one or more freeze-thaw agents, optionally one or more neutralizing agents, optionally one or more plasticizers, optionally one or more tackifiers, optionally one or more adhesion promoters, and/or optionally combinations thereof.

The instant invention comprises a laminating adhesive composition as described in further details hereinbelow. The laminating adhesive composition may further include optionally one or more surfactants, optionally one or more dispersants, optionally one or more thickeners, optionally one or more pigments, optionally one or more fillers, optionally one or more freeze-thaw agent, optionally one or more neutralizing agents, optionally one or more plasticizers, optionally one or more adhesion promoters, and/or optionally combinations thereof. The laminating adhesive composition may further include any other additives. Other exemplary additives include, but are not limited to, mildewcides and fungicides.

The term “first prepolymer,” as used herein refers to a stream containing a first prepolymer. The first prepolymer contains substantially no solvent.

In various embodiments, the first prepolymer comprises the reaction product of methylene diphenyl diisocyanate (MDI) and a first polyol. Any suitable form of MDI can be used, such as, for example, 2,2′-MDI, 2,4′-MDI, and 4,4′-MDI.

Examples of polyols that can be used to produce the first prepolymer include, but are not limited to aliphatic and aromatic polyester polyols including caprolactone based polyester polyols, seed oil based polyester polyols, any polyester/polyether hybrid polyols, polyethylene glycols, polypropylene glycols, polybutylene glycols, PTMEG-based polyether polyols; polyether polyols based on ethylene oxide, propylene oxide, butylene oxide and mixtures thereof, polycarbonate polyols, polyacetal polyols, polyacrylate polyols, polyesteramide polyols, polythioether polyols, polyolefin polyols such as saturated or unsaturated polybutadiene polyols, lower molecular weight species containing two or more free hydroxyl groups, and mixtures of any two or more thereof. In an embodiment, a blend comprising of polyether polyols based on propylene oxide and polyester polyols is used.

The first prepolymer is present in the laminating adhesive in the range of 0.1 weight percent to 99.9 weight percent. All individual values and subranges from 0.1 to 99.9 weight percent are included herein and disclosed herein; for example, the weight percent of the first prepolymer can be from a lower limit of 0.1, 5, 30, or 45 weight percent to an upper limit of 75, 82, 85, 90, or 95 weight percent. For example, laminating adhesive composition may comprise 5 to 95 percent by weight of the first prepolymer; or in the alternative, laminating adhesive composition may comprise 5 to 90 percent by weight of the first prepolymer; or in the alternative, laminating adhesive composition may comprise 5 to 85 percent by weight of the first prepolymer; or in the alternative, laminating adhesive composition may comprise 30 to 85 percent by weight of the first prepolymer.

The number average molecular weight of the first prepolymer used in the present invention may, for example, be within the range from 500 to 10000. All individual values and subranges from 500 to 10000 are included herein and disclosed herein; for example, the first prepolymer may have a number average molecular weight in the range of 1000 to about 5000.

The first prepolymer used in the present invention may be produced by any conventionally known processes, for example, solution process, hot melt process, or prepolymer mixing process in the presence of one or more inorganic catalysts, one or more organic catalysts, and/or combinations thereof. Furthermore, the first prepolymer may, for example, be produced via a process for reacting a polyisocyanate compound with an active hydrogen-containing compound and examples thereof include 1) a process for reacting a polyisocyanate compound with a polyol compound without using an organic solvent, and 2) a process for reacting a polyisocyanate compound with a polyol compound in an organic solvent, followed by removal of the solvent.

For example, the polyisocyanate compound may be reacted with the active hydrogen-containing compound at a temperature in the range of 20° C. to 120° C.; or in the alternative, in the range of 30° C. to 100° C., at an equivalent ratio of an isocyanate group to an active hydrogen group of, for example, from 1.1:1 to 3:1; or in the alternative, from 1.2:1 to 2:1. In the alternative, the prepolymer may be prepared with an excess amount of polyols thereby facilitating the production of hydroxyl terminal polymers.

The term “second prepolymer,” as used herein refers to a stream containing a second prepolymer. The second prepolymer also contains substantially no solvent.

In various embodiments, a second prepolymer comprises the reaction product of an isocyanate and one or more polyols. These polyols can be selected from the polyols listed above, and can be the same or different than the polyol(s) used to make the first prepolymer.

In various embodiments, the isocyanates used in the second prepolymer are aliphatic isocyanates. In an embodiment, the isocyanate comprises toluene diisocyanate (TDI).

Commercial examples of the second prepolymer include, but are not limited to MOR-FREE™ ELM 415A and MOR-FREE™ 200C.

The second prepolymer is present in the laminating adhesive in the range of 0.1 weight percent to 99.9 weight percent. All individual values and subranges from 0.1 to 99.9 weight percent are included herein and disclosed herein; for example, the weight percent of the second prepolymer can be from a lower limit of 0.4, 2, 8, or 15 weight percent to an upper limit of 30, 40, 55, 60, or 75 weight percent. For example, laminating adhesive composition may comprise 0.4 to 75 percent by weight of the second prepolymer; or in the alternative, laminating adhesive composition may comprise 2 to 60 percent by weight of the second prepolymer; or in the alternative, laminating adhesive composition may comprise 8 to 55 percent by weight of the second prepolymer; or in the alternative, laminating adhesive composition may comprise 15 to 40 percent by weight of the second prepolymer.

The number average molecular weight of the second prepolymer used in the present invention may, for example, be within the range from 500 to 10000. All individual values and subranges from 500 to 5000 are included herein and disclosed herein; for example, the second polyurethane prepolymer may have a number average molecular weight in the range of 500 to about 2000.

The second prepolymer can be produced in the same manner as the first prepolymer. The second prepolymer then undergoes a stripping process, in order to remove excess isocyanate monomers. The resulting second prepolymer contains less than 0.1 weight percent of monomers. All individual values between 0 and 0.1 weight percent are included herein and disclosed herein, for example, the second prepolymer can contain 0 weight percent monomers, 0.037 weight percent monomers, 0.05 weight percent monomers, 0.06 weight percent monomers, 0.07 weight percent monomers, 0.085 weight percent monomers, and 0.09 weight percent monomers.

The laminating adhesive composition may further include optionally one or more surfactants, optionally one or more dispersants, optionally one or more thickeners, optionally one or more pigments, optionally one or more fillers, optionally one or more freeze-thaw agent, optionally one or more neutralizing agents, optionally one or more plasticizers, optionally one or more tackifiers, optionally one or more adhesion promoters, and/or optionally combinations thereof.

The present invention further discloses a method for making a laminating adhesive composition comprising, consisting of, or consisting essentially of admixing i) a first prepolymer comprising the reaction product of an isocyanate selected from the group consisting of MDI and IMDI and a first polyol and ii) a second prepolymer having less than 0.1 weight percent of free monomers

In various embodiments, the components can be admixed at a temperature in the range of from 20° C. to 120° C.

In production, the laminating adhesive composition may be produced via any number of mixing devices. One such device may be a vertical mixing vessel with dual shafts, first shaft comprising a sweep blade and the second shaft comprising a high speed disperser. First and second prepolymers may be added into the vessel. At this time the sweep blade may be started, and subsequently surfactant, thickener, dispersant, freeze-thaw agents, and additive such as a propylene glycol, and plasticizer may be added to the vessel. Once enough material has been added to the vessel such that the high speed disperser blade is covered, then this blade may be started. To this mixture pigments such as titanium dioxide and fillers such as calcium carbonate may be added while maintaining the sweep blade and high speed disperser turned on. Finally, a neutralizing agent such as ammonia may be added to the vessel. Mixing should continue at, for example, 25° C. until the mixture is thoroughly mixed. The mixture may or may not be vacuumed. Vacuuming of the mixture can occur in any suitable container either in the mixer or outside of the mixer.

The laminating adhesive composition generally has a primary aromatic amine decay rate in the range of from 1 to 3 days on an oriented polyamide/polyethylene ethyl vinyl acetate film comprising 3 weight percent of ethyl vinyl acetate. All individual values and subranges between 1 and 3 days are included herein and disclosed herein, for example, the composition can have a primary aromatic amine decay rate of 1.4 days, 2 days, 2.2 days, 2.7 days, or 2.9 days.

The laminating adhesives of this invention are useful for flexible packaging for fresh food and dairy products. These can also be used as high performance laminates for coffee and snack food packaging.

### EXAMPLES

MOR-FREE 200C is an HDI based trimer available from The Dow Chemical Company.

Bester 648 is a polyester resin

Voranol P400 is a polypropylene glycol available from The Dow Chemical Company.

SYNALOX 100D45 is a poly(oxypropylene)-based lubricant available from The Dow Chemical Company.

MOR-FREE ELM 425A is a TDI/polyethylene glycol product available from The Dow Chemical Company. It contains <0.1 wt % free monomers.

MOR-FREE ELM 415A is a TDI/polyethylene glycol product available from The Dow Chemical Company. It contains 0 wt % free monomers.

MOR-FREE L75-100 is a MDI/polypropylene glycol/polyester resin product available from The Dow Chemical Company. It contains 24 wt % free monomers.

Extremely low monomer products were blended with different conventional solvent-free adhesives. The formulations are shown in Table 1, below.
Intermediate 1—49% pure MDI, 11% Bester 648, 40% SYNALOX 100D45
Intermediate 2—51% pure MDI, 8% Bester 648, 41% SYNALOX 100D45
The MDI mixture was a mixture of 4,4′, 4,2′, and 2,2′ MDI.

TABLE 1

| | Comparative | Comparative | Comparative | Comparative | Comparative | Inventive | Inventive |
|---|---|---|---|---|---|---|---|
| | Example A | Example B | Example C | Example D | Example E | Example 1 | Example 2 |
| Viscosity @ | 6200-9500 | 8300 | | 4900 | | 14700 | 8600 |
| 25° C. (mPa · s) | | | | | | | |
| NCO (% w/w) | 12.5-13.5 | 12.86 | 9.10 | 13.20 | 10.90 | 12.27 | 12.37 |
| Monomer | 24 | 24 | <0.1 | 17 | <0.1 | 17 | 18 |
| content | | | | | | | |
| (% w/w) | | | | | | | |
| Appearance | Clear | Clear | Clear | Clear | Clear | Clear | Clear |
| Pure 4,4′-MDI | 22 | 55 | | | | | |
| (% w/w) | | | | | | | |
| MDI Mixture | 33 | | | | | | |
| N3300 | | | | 8 | | | |
| Bester 648 | 9 | 9 | | | | | |
| (% w/w) | | | | | | | |
| MOR-FREE | | | | | | | |
| 200C (% w/w) | | | | | | | |
| Voranol P400 | 11 | 11 | | | | | |
| (% w/w) | | | | | | | |
| SYNALOX | 26 | 26 | | | | | |
| 100D45 | | | | | | | |
| (% w/w) | | | | | | | |
| MOR-FREE | | | 100 | | | | |
| ELM 425A | | | | | | | |
| (% w/w) | | | | | | | |
| MOR-FREE | | | | | 100 | 30 | 30 |
| ELM 415A | | | | | | | |
| (% w/w) | | | | | | | |
| Intermediate 1 | | | | 92 | | | |
| (% w/w) | | | | | | | |
| Intermediate 2 | | | | | | | 70 |
| MOR-FREE | | | | | | 70 | |
| L75-100 | | | | | | | |
| (% w/w) | | | | | | | |

Comparative Example F contained Liofol H 7735 and ethylene vinyl acetate (EVA).

TABLE 2
Bond Strength of Oriented Polyamide/Polyethylene-
Ethylene Vinyl Acetate Films

| | | Bond Strength | |
|---|---|---|---|
| | | (N/15 mm) | |
| | 1 day | 3 days (*2 days) | 7 days |
| Comparative Example A | 5.6 | 6 | 6 |
| Comparative Example B | 5.60 | 6.30 | 6.50 |
| Comparative Example C | 6.50 | 6.50 | 6.50 |
| Comparative Example F | 7.00 | 6.30 | 6.50 |
| Comparative Example D | 3.00 | 5.30 | 5.00 |
| Inventive Example 1 | 7.20 | 7.10 | 7.00 |
| Comparative Example E | 6.70 | 5.70* | 6.30 |
| Inventive Example 2 | 6.60 | 6.30* | 6.70 |

TABLE 3
Bond Strength of Polythylene Terephthalate/Aluminum
Polyethylene Films

| | 1 day | 3 days | 7 days | 15 days |
|---|---|---|---|---|
| | (N/15 | (N/15 | (N/15 | (N/15 |
| | mm) | mm) | mm) | mm) |
| Polythylene | | | | |
| terephthalate//Aluminum- | | | | |
| Polyethylene (2 g/m2) | | | | |
| Comp Example B | 5.2 | 3.3 | 3.3 | 3.5 |
| Comp Example C | 3.9 | 3.4 | 2.9 | 3.8 |
| Comp Example F | 4.8 | 4 | 3.5 | 4.5 |
| Inv Example 1 | 4.2 | 4.7 | 3.7 | 3.8 |
| Comp Example D | 3.8 | 4 | 3.8 | 3.8 |
| Comp Example E | 1.6 | 3.8 | 3.3 | |
| Inv Example 2 | 2.8 | 3.2 | 3.8 | |
| Polythylene | | | | |
| terephthalate- | | | | |
| Aluminum//Polyethylene | | | | |
| (2.5 g/m2) | | | | |
| Comp Example B | 10.8 | 10.4 | 10.6 | 10.5 |
| Comp Example C | 3.6 | 3.6 | 4.8 | 3.8 |
| Comp Example F | 3.3 | 4.1 | 6.2 | 5.5 |
| Inv Example 1 | 4 | 10.1 | 9.8 | 9.7 |
| Comp Example D | 4.1 | 3.9 | 4.2 | 7.5 |
| Comp Example E | 8.5 | 6.7 | 5.6 | |
| Inv Example 2 | 11.5 | 12 | 8.9 | |
| Oriented | | | | |
| Polyamide//Casted | | | | |
| Polypropylene (2 g/m2) | | | | |
| Comp Example B | 6.3 | 5.7 | 6.1 | |
| Comp Example C | 2.1 | 4.7 | 4.6 | |
| Comp Example F | 4.5 | 5.2 | 5.3 | |
| Inv Example 1 | 5.1 | 5.3 | 5.3 | |
| Comp Example D | 5.3 | 5.5 | 5.2 | |
| Comp Example E | 4.7 | 4.8 | 4.5 | |
| Inv Example 2 | 5.6 | 6 | 5.6 | |

TABLE 4
Bond Strength of Oriented Polyamide/Casted
Polypropylene Films (2 g/m2)

| | 1 day | 3 days | 7 days |
|---|---|---|---|
| | (N/15 mm) | (N/15 mm) | (N/15 mm) |
| Comp Example B | 6.3 | 5.7 | 6.1 |
| Comp Example C | 2.1 | 4.7 | 4.6 |
| Comp Example F | 4.5 | 5.2 | 5.3 |
| Inv Example 1 | 5.1 | 5.3 | 5.3 |
| Comp Example D | 5.3 | 5.5 | 5.2 |
| Comp Example E | 4.7 | 4.8 | 4.5 |
| Inv Example 2 | 5.6 | 6 | 5.6 |

TABLE 5
Bond Strength after thermal Cycle (30 min at 95 C.)

| | (N/15 mm) |
|---|---|
| Polyethylene teraphthalate//Aluminum- | |
| Polyethylene (2 g/m2), 30 min 95 C. | |
| Comparative Example B | 0.5 |
| Comparative Example C | 4.6 |
| Comparative Example F | 3.8 |
| Inventive Example 1 | 3.3 |
| Comparative Example D | 3.9 |
| Comparative Example E | 6 |
| Inventive Example 2 | 6 |
| Polyethylene teraphthalate- | |
| Aluminum//Polyethylene | |
| (2.5 g/m2), 30 min 95 C. | |
| Comparative Example B | 1.1 |
| Comparative Example C | 1.1 |
| Comparative Example F | 3.6 |
| Inventive Example 1 | 4.9 |
| Comparative Example D | 4 |
| Comparative Example E | 1.7 |
| Inventive Example 2 | 2.9 |
| Oriented polyamide//Casted polypropylene | |
| (2 g/m2), 30 min 121 C. | |
| Comparative Example B | 6 |
| Comparative Example C | 4.7 |
| Comparative Example F | 6 |
| Inventive Example 1 | 6 |
| Comparative Example D | 6 |
| Comparative Example E | 3.4 |
| Inventive Example 2 | 4.2 |

TABLE 6
Heat Seal Strength

| Polythylene | |
|---|---|
| teraphthalate//Aluminum// | |
| Polyethylene (2 g/m2) | Heat Seal Strength (N/15 mm) |
| Comparative Example B | 41.2 |
| Comparative Example C | 49.1 |
| Comparative Example F | 53.6 |
| Inventive Example 1 | 54.2 |
| Comparative Example D | 46.9 |

TABLE 7
Heat Seal Strength

| Oriented polyamide// | |
|---|---|
| Casted polypropylene | |
| (2 g/m2) | (N/15 mm) |
| Comparative Example B | 67.8 |
| Comparative Example C | 58.9 |
| Comparative Example F | 65.9 |
| Inventive Example 1 | 64.6 |
| Comparative Example D | 69.1 |

TABLE 8
PAA Decay (UV-Vis Method) (μg/100 mL of aniline)

| | 7 days | 3 days | 1 day |
|---|---|---|---|
| Comparative Example A | 2.38 | 6 | 6 |
| Comparative Example B | 1.25 | 6 | 6 |
| Comparative Example C | 0.2 | 0.2 | 0.2 |
| Comparative Example F | 0.6 | 2.35 | 6 |
| Inventive Example 1 | 0.24 | 0.58 | 6 |
| Comparative Example D | 0.2 | 0.44 | 6 |
| Comparative Example E | 0.2 | 0.2 | 0.2 |
| Inventive Example 2 | 0.2 | 0.2 | 6 |

### Tables 9-15: NCO Decay

TABLE 9
Comparative Example B

| | h 2919 cm−1 | h 2270 cm−1 | | | |
|---|---|---|---|---|---|
| | (A) | (B) | B/A | % ratio decrease | Days |
| 1 | 0.3228 | 0.9350 | 2.89653 | 100.00 | 0 |
| 2 | 0.0442 | 0.0082 | 0.18552 | 6.40 | 1 |
| 3 | 0.0662 | 0.0097 | 0.146526 | 5.06 | 2 |
| 4 | 0.0897 | 0.0091 | 0.101449 | 3.50 | 3 |
| 5 | 0.0699 | 0.0071 | 0.101574 | 3.51 | 6 |
| 6 | 0.0543 | 0.0054 | 0.099448 | 3.43 | 8 |
| 7 | 0.0582 | 0.0050 | 0.085911 | 2.97 | 13 |

TABLE 10
Comparative Example C

| | h 2919 cm−1 | h 2270 cm−1 | | | |
|---|---|---|---|---|---|
| | (A) | (B) | B/A | % ratio decrease | Days |
| 1 | 0.3112 | 0.8930 | 2.869537 | 100.00 | 0 |
| 2 | 0.0876 | 0.0097 | 0.110731 | 3.86 | 1 |
| 3 | 0.0863 | 0.0001 | 0.001159 | 0.04 | 2 |

TABLE 11
Comparative Example F

| | h 2867 cm−1 | h 2270 cm−1 | | | |
|---|---|---|---|---|---|
| | (A) | (B) | B/A | % ratio decrease | Days |
| 1 | 0.2537 | 0.9697 | 3.822231 | 100.00 | 0 |
| 2 | 0.0893 | 0.0150 | 0.167973 | 4.39 | 1 |
| 3 | 0.0554 | 0.0030 | 0.054152 | 1.42 | 2 |
| 4 | 0.0711 | 0.0024 | 0.033755 | 0.88 | 3 |
| 5 | 0.0801 | 0.0014 | 0.017478 | 0.46 | 6 |

TABLE 12
Inventive Example 1

| | h 2919 cm−1 | h 2270 cm−1 | | | |
|---|---|---|---|---|---|
| | (A) | (B) | B/A | % ratio decrease | Days |
| 1 | 0.3164 | 0.8189 | 2.58818 | 100.00 | 0 |
| 2 | 0.1505 | 0.0028 | 0.018605 | 0.72 | 1 |
| 3 | 0.1213 | 0.0008 | 0.006595 | 0.25 | 2 |

TABLE 13
Comparative Example D

| | h 2919 cm−1 | h 2270 cm−1 | | | |
|---|---|---|---|---|---|
| | (A) | (B) | B/A | % ratio decrease | Days |
| 1 | 0.2691 | 0.8171 | 3.036418 | 100.00 | 0 |
| 2 | 0.0861 | 0.0283 | 0.328688 | 10.82 | 1 |
| 3 | 0.0589 | 0.0161 | 0.273345 | 9.00 | 2 |
| 4 | 0.1174 | 0.0128 | 0.109029 | 3.59 | 3 |
| 5 | 0.0656 | 0.0058 | 0.088415 | 2.91 | 6 |
| 6 | 0.0542 | 0.0039 | 0.071956 | 2.37 | 8 |
| 7 | 0.0602 | 0.0048 | 0.079734 | 2.63 | 13 |

TABLE 14
Comparative Example E

| | h 2868 cm−1 | h 2270 cm−1 | | | |
|---|---|---|---|---|---|
| | (A) | (B) | B/A | % ratio decrease | Days |
| 1 | 0.3650 | 1.0682 | 2.926575 | 100 | 0 |
| 2 | 0.4036 | 0.6765 | 1.676165 | 57.27 | 1 |
| 3 | 0.1300 | 0.0197 | 0.151538 | 5.18 | 2 |
| 4 | 0.0778 | 0.0013 | 0.01671 | 0.57 | 4 |
| 5 | 0.1115 | 0.0010 | 0.008969 | 0.31 | 7 |

TABLE 15
Inventive Example 2

| | h 2862 cm−1 | h 2270 cm−1 | | | |
|---|---|---|---|---|---|
| | (A) | (B) | B/A | % ratio decrease | Days |
| 1 | 0.3265 | 1.0622 | 3.253292 | 100 | 0 |
| 2 | 0.1011 | 0.0730 | 0.722057 | 22.19 | 1 |
| 3 | 0.0872 | 0.0375 | 0.430046 | 13.22 | 2 |
| 4 | 0.0625 | 0.0021 | 0.0336 | 1.03 | 4 |
| 5 | 0.0521 | 0.0012 | 0.023033 | 0.71 | 7 |

For the reactivity test, the viscosity change under shear stress is measured. Results are shown in Table 16.

TABLE 16
Reactivity Test

| | Comparative | Comparative | Inventive | Inventive | Comparative | Comparative | Comparative |
|---|---|---|---|---|---|---|---|
| | Example A | Example B | example 2 | example 1 | Example D | Example C | Example F |
| TIME | Viscosity | Viscosity | Viscosity | Viscosity | Viscosity | Viscosity | Viscosity |
| (min) | (mPa · s) | (mPa · s) | (mPa · s) | (mPa · s) | (mPa · s) | (mPa · s) | (mPa · s) |
| 0 | 895 | 995 | 935 | 1,515 | 820 | 553 | 4,413 |
| 1 | 915 | 1,005 | 945 | 1,525 | 825 | 599 | 4,463 |
| 2 | 955 | 1,035 | 970 | 1,555 | 845 | 647 | 4,563 |
| 3 | 990 | 1,075 | 1,005 | 1,610 | 875 | 695 | 4,675 |
| 4 | 1,045 | 1,125 | 1,045 | 1,685 | 925 | 743 | 4,813 |
| 5 | 1,100 | 1,195 | 1,090 | 1,775 | 980 | 790 | 4,950 |
| 6 | 1,160 | 1,275 | 1,140 | 1,885 | 1,040 | 834 | 5,113 |
| 7 | 1,240 | 1,360 | 1,210 | 2,015 | 1,110 | 878 | 5,288 |
| 8 | 1,320 | 1,455 | 1,280 | 2,150 | 1,180 | 921 | 5,500 |
| 9 | 1,400 | 1,555 | 1,355 | 2,305 | 1,260 | 961 | 5,725 |
| 10 | 1,500 | 1,675 | 1,425 | 2,475 | 1,320 | 1,000 | 5,975 |
| 11 | 1,605 | 1,790 | 1,505 | 2,640 | 1,400 | 1,040 | 6,225 |
| 12 | 1,715 | 1,915 | 1,595 | 2,825 | 1,500 | 1,080 | 6,463 |
| 13 | 1,830 | 2,060 | 1,685 | 3,025 | 1,605 | 1,120 | 6,725 |
| 14 | 1,950 | 2,205 | 1,785 | 3,240 | 1,700 | 1,150 | 7,013 |
| 15 | 2,085 | 2,350 | 1,890 | 3,480 | 1,830 | 1,180 | 7,300 |
| 16 | 2,220 | 2,520 | 1,995 | 3,715 | 1,950 | 1,210 | 7,650 |
| 17 | 2,365 | 2,710 | 2,105 | 3,980 | 2,070 | 1,250 | 7,950 |
| 18 | 2,515 | 2,885 | 2,230 | 4,260 | 2,210 | 1,280 | 8,263 |
| 19 | 2,660 | 3,080 | 2,355 | 4,550 | 2,360 | 1,310 | 8,588 |
| 20 | 2,825 | 3,300 | 2,485 | 5,163 | 2,510 | 1,340 | 8,950 |
| 21 | 2,995 | 3,520 | 2,620 | 5,513 | 2,665 | 1,380 | 9,275 |
| 22 | 3,175 | 3,755 | 2,755 | 5,875 | 2,835 | 1,410 | 9,650 |
| 23 | 3,365 | 4,000 | 2,900 | 6,250 | 3,010 | 1,440 | 10,038 |
| 24 | 3,565 | 4,250 | 3,040 | 6,650 | 3,195 | 1,470 | 10,400 |
| 25 | 3,765 | 4,530 | 3,195 | 7,075 | 3,375 | 1,500 | 10,800 |
| 26 | 3,975 | 5,088 | 3,355 | 7,438 | 3,560 | 1,530 | 11,163 |
| 27 | 4,185 | 5,388 | 3,530 | 7,875 | 3,750 | 1,550 | 11,575 |
| 28 | 4,410 | 5,700 | 3,715 | 8,363 | 3,960 | 1,580 | 12,700 |
| 29 | 4,650 | 6,050 | 3,905 | 8,913 | 4,170 | 1,610 | 13,200 |
| 30 | 5,050 | 6,400 | 4,095 | 9,425 | 4,395 | 1,640 | 13,700 |
| 31 | 5,338 | 6,775 | 4,280 | 9,938 | 4,640 | 1,680 | 14,150 |
| 32 | 5,650 | 7,188 | 4,455 | 10,550 | 5,063 | 1,720 | 14,700 |
| 33 | 5,950 | 7,613 | 4,650 | 11,163 | 5,325 | 1,750 | 15,200 |
| 34 | 6,288 | 8,038 | 4,963 | 11,863 | 5,613 | 1,780 | 15,750 |
| 35 | 6,588 | 8,475 | 5,188 | 12,950 | 5,925 | 1,800 | 16,300 |
| 36 | 6,888 | 8,950 | 5,425 | 13,700 | 6,213 | 1,830 | 16,900 |
| 37 | 7,225 | 9,463 | 5,700 | 14,675 | 6,538 | 1,860 | 17,450 |
| 38 | 7,588 | 10,000 | 5,975 | 15,670 | 6,888 | 1,890 | 18,050 |
| 39 | 7,988 | 10,575 | 6,225 | 16,670 | 7,250 | 1,920 | 18,600 |
| 40 | 8,350 | 11,125 | 6,500 | 17,770 | 7,638 | 1,950 | 19,200 |
| 41 | 8,713 | 11,688 | 6,800 | 19,055 | 8,025 | 1,970 | 19,850 |
| 42 | 9,113 | 12,750 | 7,125 | 20,275 | 8,438 | 2,000 | 20,400 |
| 43 | 9,500 | 13,450 | 7,475 | 21,525 | 8,838 | 2,030 | 21,100 |
| 44 | 9,988 | 14,200 | 7,863 | 22,875 | 9,263 | 2,060 | 21,800 |
| 45 | 10,450 | 14,950 | 8,238 | 24,200 | 9,700 | 2,080 | 22,450 |
| 46 | 10,913 | 15,700 | 8,563 | 25,575 | 10,163 | 2,130 | 23,150 |
| 47 | 11,363 | 16,450 | 8,875 | 26,900 | 10,638 | 2,150 | 23,850 |
| 48 | 11,825 | 17,200 | 9,225 | 28,275 | 11,150 | 2,180 | 24,550 |
| 49 | 12,650 | 18,050 | 9,563 | 29,725 | 11,638 | 2,210 | 25,350 |
| 50 | 13,200 | 18,950 | 9,963 | 31,255 | 12,600 | 2,240 | 25,650 |
| 51 | 13,800 | 19,750 | 10,350 | 32,725 | 13,150 | 2,270 | 26,300 |
| 52 | 14,400 | 20,650 | 10,738 | 34,505 | 13,750 | 2,290 | 27,100 |
| 53 | 15,050 | 21,500 | 11,150 | 35,870 | 14,400 | 2,320 | 27,750 |
| 54 | 15,750 | 22,400 | 11,625 | 37,400 | 15,000 | 2,340 | 28,450 |
| 55 | 16,500 | 23,300 | 12,500 | 38,800 | 15,700 | 2,360 | 29,250 |
| 56 | 17,300 | 24,600 | 13,050 | 40,100 | 16,500 | 2,390 | 30,100 |
| 57 | 17,950 | 25,550 | 13,600 | 41,890 | 17,300 | 2,420 | 30,850 |
| 58 | 18,600 | 26,680 | 14,150 | 43,200 | 17,950 | 2,450 | 31,700 |
| 59 | 19,300 | 27,400 | 14,750 | | 18,500 | 2,470 | 32,650 |
| 60 | 20,100 | 28,450 | 15,400 | | | 2,500 | 33,600 |

### Test Methods

### Bond Strength

Bond strength was measured using a Zwicki machine at a test speed of 100 mm/min. The average force required to separate each ply of a test specimen was taken as the result for a single specimen. Five specimens were tested, and the average of the five specimens tested was reported as the final result.

### Heat Seal Strength

Heat seal strength was measured with a HSG-ETK heat sealing press (Brugger Feinmechanik GmbH). The settings were as follows: Jaws: flat 150×10 mm. Jaws (Upper and Lower) Temperature: For PE: 150° C. cPP: 160° C., Coex: 145° C. Dwell time: 1 sec. Pressure: 4 bar.

### PAA Decay

This procedure describes the method for the determination of primary aromatic amines (PAAs) in food simulants distilled water and 3% acetic acid. The content of primary aromatic amines in food simulants is expressed as content of aniline, in mg/l simulant. The method is appropriate for the quantitative determination of PAAs in the range from 0.2 μg/100 ml to 6 μg/100 ml (from 2 ppb to 60 ppb). Primary aromatic amines (PAAs) can occur in food contact articles as residual monomers, as hydrolysis products of isocyanates or as contaminants of azodyes. The PAAs possibly existing in the food simulant are subjected to diazotation by addition of hydrochloric acid and sodium nitrite solution. Ammonium sulfamate is then added to prevent excess nitrosation agent from destroying the nitrosated PAAs. Subsequently, nitrosated PAAs are coupled with N-(1-naphthyl)-ethylenediamine dihydrochloride to produce a purple-coloured solution. Concentration of the dye is performed by means of solid phase extraction (SPE) columns. The content of primary aromatic amines, calculated as aniline, is determined photometrically at 550 nm. Calibration is achieved by analysis of relevant simulants containing known amounts of aniline.

### NCO Decay

Free NCO decay was measured using Infrared spectroscopy by monitoring the decay of the peak at 2270 cm-1. Its intensity could be influenced by coating weight's adhesive and its homogeneity. It is therefore important to take as internal reference a peak that is not influenced by the former described variables. In polyester based polyurethanes, the internal reference peak is the one at 725 cm-1, while in polyether based polyurethanes the internal reference peak is the CH3 in range 2900-2700 cm-1. Alternatively, peak 1598 cm-1 could be considered in case of aromatic isocyanates.

### Reactivity Test

The reactivity of adhesives was measured using a Rheometer Anton Paar Physica MCR 301. Adhesive technologies involve both solvent-less and solvent-based systems. In a cone and plate rheometer the liquid is placed on a horizontal plate and a shallow cone placed into it. The angle between the surface of the cone and the plate is of the order of 1 degree—i.e. the cone is shallow. The plate was rotated and the force on the cone was measured. In a rotational rheometer the liquid was placed within the annulus of one cylinder inside another. One of the cylinders was rotated at a set speed to determine the shear rate inside the annulus. For reactivity measurements, the annulus was set at a specific speed and the increase of viscosity was recorded every minute for a period of 60 minutes (shear rate=10 l/s, Rotations per minute=1.68).

1. A laminating adhesive composition comprising
a) a first prepolymer comprising the reaction product of a methylene diphenyl diisocyanate and a first polyol and
b) a second prepolymer comprising the reaction product of an isocyanate and a second polyol, wherein the second prepolymer has less than 0.1 weight percent of free isocyanate monomers
and wherein the laminating adhesive composition is substantially free of solvents.

2. The laminating adhesive composition of claim 1, wherein the first prepolymer is present in the range of 0.1 weight percent to 99.9 weight percent and the second prepolymer is present in the range of from 0.1 weight percent to 99.9 weight percent, based on the total weight of the aqueous composition.

3. The laminating adhesive composition of claim 1 wherein the first polyol and the second polyol are the same or different and are selected from the group consisting of polyethers, polyesters, and combinations thereof.

4. The laminating adhesive composition of claim 1 wherein the methylene diphenyl diisocyanate of the first prepolymer is 4,4′-methylene diphenyl diisocyanate.

5. The laminating adhesive composition of claim 1 wherein the isocyanate of the second prepolymer comprises toluene diisocyanate.

6. A method for making a laminating adhesive composition comprising admixing
i) a first prepolymer comprising the reaction product of a methylene diphenyl diisocyanate and a first polyol and
ii) a second prepolymer comprising the reaction product of an isocyanate having less than 0.1 weight percent of free monomers and a second polyol.

7. A method in accordance with claim 6 wherein i) and ii) are admixed at a temperature in the range of from 20° C. to 120° C.

8. The laminating adhesive composition in accordance with claim 1 having a primary aromatic amine decay rate in the range of from 1 to 3 days on an oriented polyamide/polyethylene ethyl vinyl acetate film comprising 3 weight percent ethyl vinyl acetate.
